(19) United States
(12) Patent Application Publication
(10) Pub. No.: US 2026/0292685 A1
(43) Pub. Date: Sep. 24, 2026

(54) RANGING METHOD AND APPARATUS WITH POWER-OPTIMIZED RANGING MECHANISM FOR DEVICE POSITIONING

(71) Applicant: MEDIATEK INC., Hsinchu City (TW)

(72) Inventors: I-Cheng Tsai, Hsinchu City (TW); Shun-Yong Huang, Hsinchu City (TW); Po-Jung Chiu, Hsinchu City (TW)

(73) Assignee: MEDIATEK INC., Hsinchu City (TW)

(21) Appl. No.: 19/536,246

(22) Filed: Feb. 11, 2026

Related U.S. Application Data
(60) Provisional application No. 63/774,197, filed on Mar. 19, 2025.

(51) Int. Cl. H04W 52/02; G01S 11/06; H04B 17/318

(52) U.S. Cl. CPC H04W 52/0229; G01S 11/06; H04B 17/318

(57) ABSTRACT

A power-optimized ranging method for use in a wireless communication device includes: receiving a ranging request from a host system to determine a distance between the wireless communication device and a target AP; determining whether a ranging mode is a power-saving ranging mode; in response to the ranging request and a determination that the ranging mode is the power-saving ranging mode, determining whether a displacement of the wireless communication device exceeds a predetermined displacement threshold; if the displacement does not exceed the predetermined displacement threshold, generating a ranging result indicating the distance with respect to the target AP based on historical ranging results associated with the target AP and refraining from transmitting range measurement packets to the target AP; and if the displacement exceeds the predetermined displacement threshold, performing a ranging operation with the target AP to generate the ranging result.

### CROSS REFERENCE TO RELATED APPLICATIONS

This application claims the benefit of U.S. Provisional Application No. 63/774,197, filed on Mar. 19, 2025. The content of the application is incorporated herein by reference.

### BACKGROUND

The present invention relates to wireless communication systems, and more particularly, to a method and apparatus of power-optimized ranging for device positioning.

Location-Based Services (LBS) have become integral to modern mobile applications, ranging from indoor navigation and asset tracking to geofencing and proximity marketing. While global navigation satellite systems (GNSS) function effectively outdoors, their signals are often attenuated or blocked in indoor environments. Consequently, indoor positioning solutions based on existing wireless infrastructures, such as Wi-Fi, are widely deployed for indoor localization.

Early approaches to Wi-Fi positioning relied primarily on received signal strength indicator (RSSI) fingerprinting. Although power-efficient, RSSI-based positioning may suffer from significant signal fluctuation due to multipath fading and environmental obstructions, often resulting in coarse accuracy on the order of several meters (e.g., approximately 5 to 10 meters). To improve accuracy, IEEE 802.11 introduced round-trip time (RTT)-based ranging mechanisms, such as fine timing measurement (FTM) as specified in IEEE 802.11mc (Wi-Fi RTT), and subsequent amendments (e.g., IEEE 802.11az) further enhance ranging performance. Such ranging procedures estimate a distance between a wireless communication device (e.g., a smartphone) and an access point (AP) based on timing measurements obtained from dedicated measurement packets exchanges.

However, improved ranging accuracy may come at the cost of increased power consumption. Unlike passive RSSI monitoring, RTT-based ranging typically requires the wireless connectivity subsystem to initiate an active measurement exchange (e.g., an FTM exchange) with an AP. To mitigate noise and multipath effects, a ranging result may be derived from multiple measurement packet exchanges within a packet burst. Furthermore, to estimate a 2D position via trilateration, a host system commonly uses ranging results with respect to at least three distinct APs within a positioning interval.

In continuous tracking scenarios, such as indoor navigation, a host processor may repeatedly issue ranging requests to update a device location estimate. Conventional implementations may execute active measurement exchanges in response to each request regardless of whether the device is stationary or exhibits limited movement. Frequent transmission and reception of range measurement packets can impose a substantial burden on battery-powered devices. Accordingly, there is a need for techniques that intelligently manage ranging operations to reduce power consumption while maintaining positioning performance and continuity.

### SUMMARY

With this in mind, it is one object of the present invention to provide a method and apparatus for power-optimized Wi-Fi ranging that reduces unnecessary active ranging operations while maintaining positioning continuity for location-based services. In some embodiments, a ranging apparatus receives a ranging request from a host system and determines whether the ranging request is to be processed in a power-saving ranging mode. In the power-saving ranging mode, the ranging apparatus performs a displacement checking operation to assess whether displacement of a wireless communication device is within an acceptable range. The displacement checking operation may be based on one or more signal strength indicators with a target access point (AP) and/or motion data from an inertial measurement unit. If the displacement does not exceed a predetermined displacement threshold, the ranging apparatus refrains from initiating a new ranging operation with the target AP and instead generates a current ranging result based on historical ranging results. If the estimated displacement exceeds the displacement threshold, the ranging apparatus initiates an active ranging operation with the target AP to generate a new ranging result.

In addition, even when a new ranging operation is performed, the ranging apparatus may adapt ranging parameters based on the ranging mode, such as using a reduced number of range measurement packets/frames per burst in the power-saving ranging mode and a full ranging configuration in an accuracy-optimized ranging mode using a full number of range measurement packets/frames per burst. By suppressing active ranging operation when displacement is limited and by tailoring range measurement overhead when the ranging operation is necessary, the present invention effectively reduce airtime and power consumption of the ranging apparatus, thereby extending battery life of the device in continuous position tracking scenarios while providing timely per-AP ranging results usable for device positioning.

According to one embodiment, a power-optimized ranging method for use in a wireless communication device is provided. The method comprises: receiving a ranging request from a host system to determine a distance between the wireless communication device and a target access point (AP); determining whether a ranging mode corresponding to the ranging request is a power-saving ranging mode; in response to the ranging request and a determination that the ranging mode is the power-saving ranging mode, determining whether a displacement of the wireless communication device exceeds a predetermined displacement threshold; in response to a determination that the displacement does not exceed the predetermined displacement threshold, generating a ranging result indicating the distance with respect to the target AP based on historical ranging results associated with the target AP and refraining from transmitting range measurement packets to the target AP; and in response to a determination that the displacement exceeds the predetermined displacement threshold, performing a ranging operation with the target AP to generate the ranging result.

According to one embodiment, a ranging apparatus is provided. The ranging apparatus comprises a processor and a memory. The memory stores instructions. When the instructions are executed by the processor, the ranging apparatus is caused to: receive a ranging request from a host system to determine a distance between a wireless communication device and a target access point (AP); determine whether a ranging mode corresponding to the ranging request is a power-saving ranging mode; in response to the ranging request and a determination that the ranging mode is the power-saving ranging mode, determine whether a displacement of the wireless communication device exceeds a predetermined displacement threshold; in response to a determination that the displacement does not exceed the predetermined displacement threshold, generate a ranging result indicating the distance with respect to the target AP based on historical ranging results associated with the target AP, and refrain from transmitting range measurement packets to the target AP; and in response to a determination that the displacement exceeds the predetermined displacement threshold, perform a ranging operation with the target AP to generate the ranging result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating an exemplary wireless communication environment in which a power-optimized ranging method of the present invention is implemented.

FIG. 2 illustrates a schematic diagram of a wireless communication device according to an embodiment of the present invention.

FIG. 3 illustrates a flowchart of a power-optimized method for power-optimized ranging operations according to one embodiment of the present invention.

FIG. 4 illustrates a simplified flow chart of a power-optimized ranging method according to one embodiment of the present invention.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Reference throughout this specification to “one embodiment” or “an embodiment” means that a particular feature, structure or characteristic described in connection with the embodiment or example is included in at least one embodiment of the present embodiments. Thus, appearances of the phrases “in one embodiment” or “in an embodiment” in various places throughout this specification are not necessarily all referring to the same embodiment. Furthermore, the particular features, structures or characteristics may be combined in any suitable combinations and/or sub-combinations in one or more embodiments.

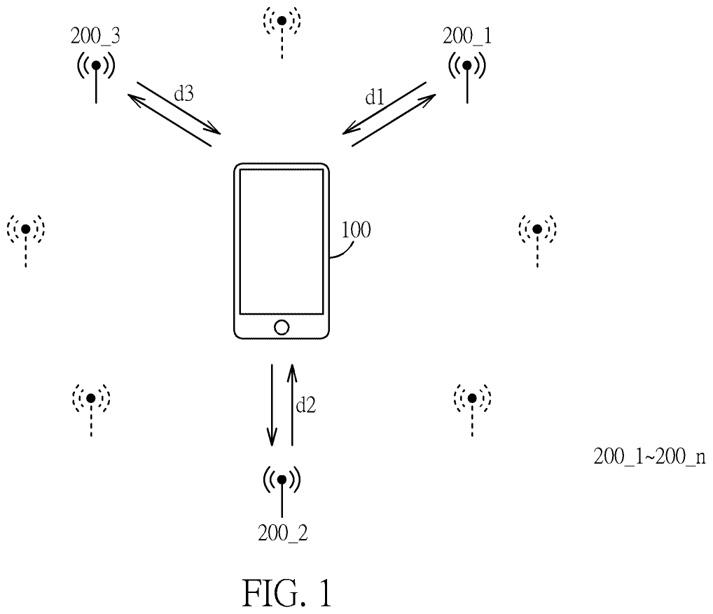

FIG. 1 is a schematic diagram illustrating an exemplary wireless communication environment in which a power-optimized ranging method and apparatus of the present invention may be implemented. As illustrated, the exemplary wireless communication environment includes a wireless communication device 100 located within a venue served by a plurality of access points (APs) 200_1-200_n.

The wireless communication device 100 may be any electronic device capable of wireless connectivity. According to various embodiments of the present invention, the wireless communication device 100 is not limited thereto and may encompass a smartphone, a tablet computer, a laptop computer, a wearable device, a portable device, an Internet of Things (IoT) device, or an autonomous mobile robot.

The APs 200_1-200_n are primarily configured to provide wireless network connectivity to the wireless communication device 100, bridging a wireless medium to a backbone network (e.g., a local area network (LAN) or a wide area network (WAN)). The wireless communication device 100 typically associates with one or more of the APs 200_1-200_n to exchange user data. The APs 200_1-200_n may be arranged in various network topologies. In some embodiments, the APs 200_1-200_n are deployed as respective basic service sets (BSSs) and are interconnected via a distribution system to form an extended service set (ESS). In some embodiments, the APs 200_1-200_n may form a wireless mesh network in which at least some APs communicate with each other.

In addition to data transport, the APs 200_1-200_n may support positioning-related functionality for location-based services (LBS). In particular, the APs 200_1-200_n may serve as anchors with known locations for indoor positioning. The wireless communication device 100 may perform Wi-Fi ranging (round-trip time (RTT)-based range measurement or time-of-flight (TOF)-based range measurement) with the APs 200_1-200_n in accordance with IEEE 802.11 standards, for example using IEEE 802.11mc fine timing measurement (FTM) and/or IEEE 802.11az null data packet (NDP) ranging procedures. The APs 200_1-200_n need not be under a common administrative domain; in some embodiments, the wireless communication device 100 may range to neighboring APs associated with different networks, provided such APs support and permit participation in the ranging procedure.

To perform positioning, the wireless communication device 100 initiates a ranging operation with multiple ones of the APs 200_1-200_n. It is important to note that the set of APs used for ranging may differ from the serving AP used for data transmission of the wireless communication device 100. To resolve a 2D location via trilateration or multilateration, the wireless communication device 100 performs ranging operations with at least three APs selected from the APs 200_1-200_n.

The ranging operation derives distance based on the RTT of packets/frames exchanged between the wireless communication device 100 and the APs 200_1-200_n. As illustrated in FIG. 1, the wireless communication device 100 may obtain a range d1 to its currently associated serving AP 200_1, while also obtaining ranges d2 and d3 to neighboring non-serving APs 200_2 and 200_3.

To achieve high accuracy of ranging, the ranging operation may require the wireless communication device 100 to transmit and receive multiple range measurement packets/frames. For example, a single ranging result may require a burst of approximately 6 pairs of transmit and receive packet exchanges with a target AP. This transmission behavior poses a significant challenge for power consumption, especially when the wireless communication device 100 performs frequent ranging for continuous location tracking.

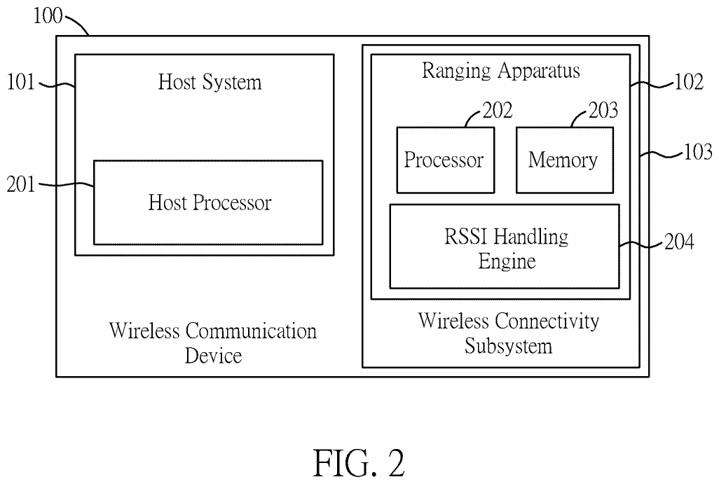

FIG. 2 illustrates a schematic diagram of a wireless communication device 100 according to an embodiment of the present invention. The wireless communication device 100 includes a host system 101 (which further includes a host/application processor 201) and a ranging apparatus 102 coupled to the host system 101. The host processor 201 may execute an operating system and one or more location-related applications. The ranging apparatus 102 may be included in a wireless connectivity subsystem 103, wherein the wireless connectivity subsystem 103 could be implemented as a standalone Wi-Fi chipset or as an integrated connectivity core within a system-on-chip (SoC). In some embodiments, the ranging apparatus 102 may further include a processor 202 (which may be embedded microcontroller and/or a digital signal processor (DSP)) with local memory 203 to execute firmware instructions for performing a power-optimized ranging method as described herein. Furthermore, the ranging apparatus 102 may output per-AP ranging result associated with at least three APs from the APs 200_1-200_n to the host system 101. Accordingly, the host system 101 resolves a position of the wireless communication device 100 based on these per-AP ranging results through trilateration computation.

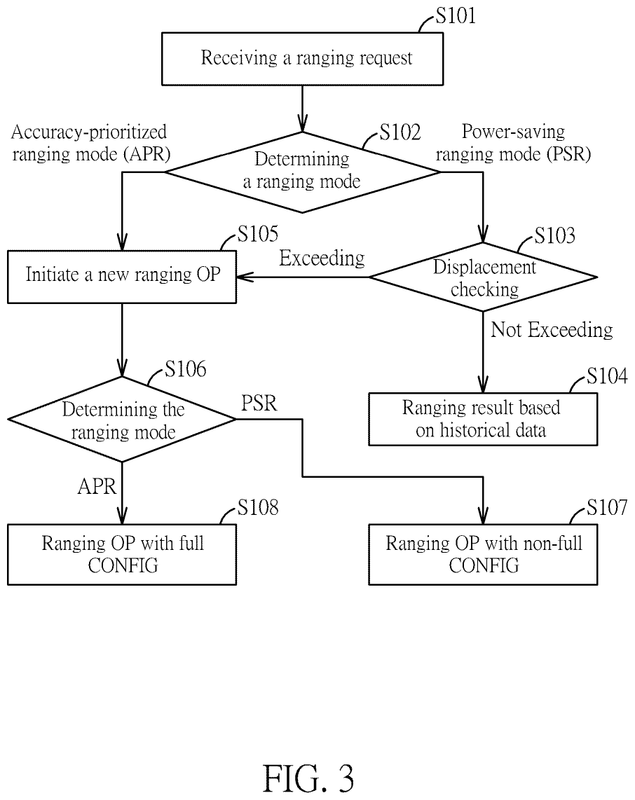

FIG. 3 illustrates a flowchart of a method for power-optimized ranging according to one embodiment of the present invention.

At step S101, the process begins when the ranging apparatus 102 receives a ranging request from the host system 101. The ranging request may be generated by a location-related application (e.g., an indoor positioning application) executed on the host system 101 to request per-AP ranging results corresponding to a set of target APs (e.g., APs 200_1-200_3).

At step S102, in response to receiving the ranging request, the ranging apparatus 102 determines a current ranging mode. Specifically, the ranging apparatus 102 may determine whether it is configured to operate in a power-saving ranging mode or an accuracy-prioritized ranging mode.

If the ranging apparatus 102 is configured in the accuracy-prioritized ranging mode, the process may proceed to perform a standard ranging operation (e.g., an IEEE 802.11mc FTM exchange and/or an IEEE 802.11az ranging procedure) associated with a target AP (e.g., one of the APs 200_1-200_3) to obtain a ranging result associated with the target AP, ensuring accurate distance estimation between the wireless communication device 100 and the target AP. If the ranging apparatus 102 is configured in the power-saving ranging mode, the process proceeds to step S103 to perform a displacement checking operation.

At step S103, the ranging apparatus 102 performs the displacement checking operation to determine whether previously generated/historical ranging results associated with the target AP remains valid, wherein the previously generated/historical ranging results are recorded in the ranging apparatus 102. In the displacement checking operation, the ranging apparatus 102 evaluates whether an estimated displacement of the wireless communication device 100 exceeds a predetermined displacement threshold. When the estimated displacement does not exceed the predetermined displacement threshold, the ranging apparatus 102 refrains from initiating a new ranging operation associated with the target AP. Instead, the ranging apparatus 102 generates the ranging result, based on the previously generated/historical ranging results associated with the target AP, for the host system 101 (Step S104). When the estimated displacement exceeds the predetermined displacement threshold, the ranging apparatus 102 proceeds to initiate a new ranging operation (Step S105) associated with the target AP to generate a new ranging result for the host system 101.

In one embodiment, the displacement checking operation at step S103 is based on a variation in received signal strength indicator (RSSI) measurements associated with the target AP. For example, the ranging apparatus 102 determines whether an RSSI variation between a current RSSI value and a previous RSSI value is within a predetermined tolerance. In one example, the predetermined tolerance is 5 dBm. If the RSSI variation is within the predetermined tolerance, the ranging apparatus 102 determines that the displacement of the wireless communication device 100 does not exceed the predetermined displacement threshold and reuses the previously generated/historical ranging results associated with the target AP (Step S104). If the RSSI variation is outside the predetermined tolerance, the ranging apparatus 102 determines that the displacement of the wireless communication device 100 exceeds the predetermined displacement threshold and initiates a new ranging operation to obtain a new ranging result (Step S105).

In one embodiment, the ranging apparatus 102 further determines whether the previous RSSI value is stale. For example, the ranging apparatus 102 determines a time difference between a timestamp associated with the previous RSSI value and a current time. If the time difference exceeds a staleness threshold, the ranging apparatus 102 determines that the RSSI variation is unreliable and initiates a new ranging operation associated with the target AP (Step S105).

In one embodiment, the displacement checking operation step S103 is based on motion sensor data. For example, the ranging apparatus 102 obtains motion data from one or more inertial measurement units (IMUs) inside the wireless communication device 100, such as accelerometer and/or gyroscope, and estimates a displacement (or a motion state) of the wireless communication device 100 over a time interval. If the estimated displacement exceeds the predetermined displacement threshold (or if motion state indicates significant movement), the ranging apparatus 102 initiates a new ranging operation associated with the target AP (Step S105); otherwise, the ranging apparatus 102 reuses the previously generated/historical ranging results associated with the target AP (Step S104).

In one embodiment, the displacement checking operation step S103 is performed by referencing both the RSSI variation and the motion data from the one or more IMUs. The ranging apparatus 102 may determine whether an estimated displacement exceeds the predetermined displacement threshold based on a joint decision derived from the RSSI variation and the motion data. For example, the ranging apparatus 102 determines that the previously generated/historical ranging results remains valid when both (a) the RSSI variation is within the predetermined tolerance and (b) the estimated displacement based on the motion data does not exceed the displacement threshold (or motion state indicates a stationary or low-motion state); otherwise, the ranging apparatus 102 initiates a new ranging operation associated with the target AP to obtain a new ranging result (Step S105).

In some embodiments, obtaining the RSSI value associated with the target AP does not require initiating an active scan or transmitting probe requests. Instead, the ranging apparatus 102 may include an RSSI handling engine 204. The RSSI handling engine 204 may be dedicated hardware and configured to obtain RSSI values from received IEEE 802.11 beacon or management frames. The RSSI handling engine 204 may passively monitor beacon frames from neighboring APs (including APs that are not serving the wireless communication device 100) during periodic listening intervals, and may store one or more RSSI values for subsequent access. For example, the RSSI handling engine may obtain RSSI values from beacon frames received from (i) a serving AP with which the wireless communication device 100 is associated (e.g., beacons corresponding to delivery traffic indication message (DTIM) information) and/or (ii) neighboring non-serving APs (e.g., APs in overlapping basic service sets (OBSS)). Accordingly, when performing the displacement checking operation, the ranging apparatus 102 may directly retrieve stored RSSI values from the RSSI handling engine 204, thereby reducing or avoiding additional transmit operations and the overhead associated with an active scan.

When the estimated displacement of the wireless communication device 100 does not exceed the predetermined displacement threshold), the process proceeds to step S104. At step S104, the ranging apparatus 102 refrains from initiating a new ranging operation with the target AP, for example, by refraining from transmitting range measurement packets/frames to the target AP. Instead, the ranging apparatus 102 generates a current ranging result based on historical/previously generated ranging results associated with the target AP. In some embodiments, the ranging apparatus 102 selects a most recent ranging result associated with the target AP as the current ranging result for output to the host system 101. In other embodiments, the ranging apparatus 102 performs a statistical estimation based on one or more historical/previously generated ranging results (through averaging, weighted averaging or other histogram-based algorithms) associated with the target AP to generate the current ranging result. By avoiding additional ranging operations when the displacement is within an acceptable range, the ranging apparatus 102 reduces airtime and power consumption while still satisfying the ranging request from the host system 101.

Furthermore, even when initiating a new ranging operation is deemed necessary, the ranging apparatus 102 may apply a secondary power-saving technique by adapting the measurement parameters. At step S106, the ranging apparatus 102 determines the current ranging mode is either the power-saving ranging mode or the accuracy-prioritized ranging mode and accordingly selects a corresponding ranging configuration.

If the ranging apparatus 102 is configured in the power-saving ranging mode, the ranging apparatus 102 performs the ranging operation with a non-full ranging configuration (Step S107). For example, the ranging apparatus 102 performs the ranging operation using a reduced number of range measurement packets/frames (including transmit and receive packets/frames) per burst, thereby saving power consumption. If the ranging apparatus 102 is configured in the accuracy-prioritized ranging mode, the ranging apparatus 102 performs the ranging operation with a full ranging configuration (Step S108). For example, the ranging apparatus 102 performs the ranging operation using a full number (larger than that in the non-full ranging configuration) of range measurement packets/frames (including transmit and receive packets/frames) per burst, thereby improving ranging accuracy.

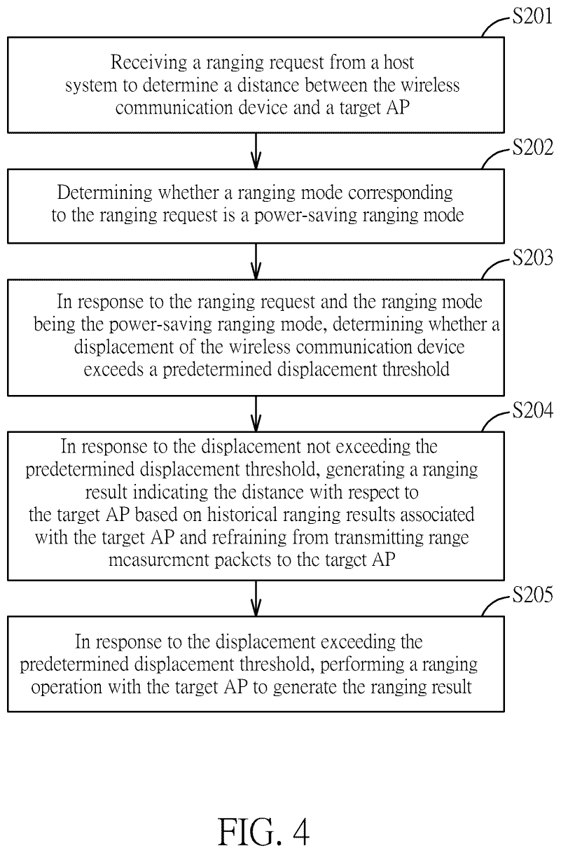

FIG. 4 illustrates a simplified flow chart of a power-optimized ranging method according to one embodiment of the present invention. As shown in the figure, the method includes the following steps:

Step S201: receiving a ranging request from a host system to determine a distance between the wireless communication device and a target access point (AP);

Step S202: determining whether a ranging mode corresponding to the ranging request is a power-saving ranging mode;

Step S203: in response to the ranging request and a determination that the ranging mode is the power-saving ranging mode, determining whether a displacement of the wireless communication device exceeds a predetermined displacement threshold;

Step S204: in response to a determination that the displacement does not exceed the predetermined displacement threshold, generating a ranging result indicating the distance with respect to the target AP based on historical ranging results associated with the target AP and refraining from transmitting range measurement packets to the target AP; and

Step S205: in response to a determination that the displacement exceeds the predetermined displacement threshold, performing a ranging operation with the target AP to generate the ranging result.

Since the principle and specific details of the foregoing steps have been described expressly in the above embodiments, further descriptions will not be repeated here. It should be noted that the above flow may achieve better performance and accuracy of ranging and positioning by adding other extra steps or making appropriate modifications and/or adjustments.

In conclusion, the ranging method and apparatus of the present invention intelligently suppress unnecessary Wi-Fi ranging operations and adapt measurement overhead based on device displacement and ranging mode, thereby reducing airtime and power consumption while maintaining reliable ranging results for continuous indoor positioning and other location-based services.

Embodiments in accordance with the present embodiments can be implemented as an apparatus, method, or computer program product. Accordingly, the present embodiments may take the form of an entirely hardware embodiment, an entirely software embodiment, or an embodiment combining software and hardware aspects that can all generally be referred to herein as a “module” or “system.” Furthermore, the present embodiments may take the form of a computer program product embodied in any tangible medium of expression having computer-usable program code embodied in the medium. In terms of hardware, the present invention can be accomplished by applying any of the following technologies or related combinations: an individual operation logic with logic gates capable of performing logic functions according to data signals, and an application specific integrated circuit (ASIC), a programmable gate array (PGA) or a field programmable gate array (FPGA) with a suitable combinational logic.

The flowchart and block diagrams in the flow diagrams illustrate the architecture, functionality, and operation of possible implementations of systems, methods, and computer program products according to various embodiments of the present embodiments. In this regard, each block in the flowchart or block diagrams may represent a module, segment, or portion of code, which comprises one or more executable instructions for implementing the specified logical function(s). It is also noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions. These computer program instructions can be stored in a computer-readable medium that directs a computer or other programmable data processing apparatus to function in a particular manner, such that the instructions stored in the computer-readable medium produce an article of manufacture including instruction means which implement the function/act specified in the flowchart and/or block diagram block or blocks.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A power-optimized ranging method for use in a wireless communication device, comprising:
receiving a ranging request from a host system to determine a distance between the wireless communication device and a target access point (AP);
determining whether a ranging mode corresponding to the ranging request is a power-saving ranging mode;
in response to the ranging request and a determination that the ranging mode is the power-saving ranging mode, determining whether a displacement of the wireless communication device exceeds a predetermined displacement threshold;
in response to a determination that the displacement does not exceed the predetermined displacement threshold, generating a ranging result indicating the distance with respect to the target AP based on historical ranging results associated with the target AP and refraining from transmitting range measurement packets to the target AP; and
in response to a determination that the displacement exceeds the predetermined displacement threshold, performing a ranging operation with the target AP to generate the ranging result.

2. The ranging method of claim 1, the step of determining whether the displacement of the wireless communication device exceeds the predetermined displacement threshold comprises:
determining whether a received signal strength indicator (RSSI) variation associated with the target AP is within a predetermined tolerance; and
determining that the displacement of the wireless communication device does not exceed the predetermined displacement threshold if the RSSI variation is within the predetermined tolerance.

3. The ranging method of claim 2, wherein the step of determining whether the displacement of the wireless communication device exceeds the predetermined displacement threshold further comprises:
determining a time difference between a current time and a timestamp associated with a previous RSSI value used to calculate the RSSI variation; and
in response to the time difference exceeding a staleness threshold, determining that the RSSI variation is unreliable and performing the ranging operation with the target AP to generate the ranging result.

4. The ranging method of claim 2, further comprising:
determining the RSSI variation through obtaining at least one RSSI value associated with the target AP without initiating an active scan or transmitting a probe request, by passively receiving one or more beacon frames, wherein the one or more beacon frames include beacon frames transmitted by a serving AP with which the wireless communication device is associated and/or beacon frames transmitted by one or more neighboring non-serving APs in overlapping basic service sets (OBSS); and
extracting the at least one RSSI value from the passively received one or more beacon frames.

5. The ranging method of claim 1, wherein the step of determining whether the displacement of the wireless communication device exceeds the predetermined displacement threshold comprises:
obtaining motion data from one or more inertial sensors inside the wireless communication device;
estimating a displacement of the wireless communication device based on the motion data; and
determining whether the displacement of the wireless communication device exceeds the predetermined displacement based on the estimated displacement and/or a motion state indicated by the motion data.

6. The ranging method of claim 1, wherein the step of generating the ranging result indicating the distance with respect to the target AP based on the historical ranging results associated with the target AP comprises at least one of:
selecting a most recent ranging result from the historical ranging result associated with the target AP as a current ranging result; or
computing the current ranging result by performing a statistical estimation over multiple ones of the historical ranging results associated with the target AP.

7. The ranging method of claim 1, wherein the step of performing the ranging operation with the target AP comprises:
selecting a ranging configuration for performing the ranging operation based on a current ranging mode of the wireless communication device;
when the ranging mode is the power-saving ranging mode, performing the ranging operation using a reduced number of range measurement packets per burst; and
when the ranging mode is an accuracy-optimized ranging mode, performing the ranging operation using a full number of range measurement packets per burst.

8. The ranging method of claim 1, wherein the ranging operation is performed in accordance with an IEEE 802.11 ranging procedure, comprising at least one of an IEEE 802.11 fine timing measurement (FTM) procedure and an IEEE 802.11az ranging procedure.

9. A ranging apparatus, comprising:
a processor; and
a memory storing instructions that, when executed by the processor, cause the ranging apparatus to:
receive a ranging request from a host system to determine a distance between a wireless communication device and a target access point (AP);
determine whether a ranging mode corresponding to the ranging request is a power-saving ranging mode;
in response to the ranging request and a determination that the ranging mode is the power-saving ranging mode, determine whether a displacement of the wireless communication device exceeds a predetermined displacement threshold;
in response to a determination that the displacement does not exceed the predetermined displacement threshold, generate a ranging result indicating the distance with respect to the target AP based on historical ranging results associated with the target AP, and refrain from transmitting range measurement packets to the target AP; and
in response to a determination that the displacement exceeds the predetermined displacement threshold, perform a ranging operation with the target AP to generate the ranging result.

10. The ranging apparatus of claim 9, when the instructions are executed by the processor, the ranging apparatus is caused to:
determine whether a received signal strength indicator (RSSI) variation associated with the target AP is within a predetermined tolerance; and
determine that the displacement of the wireless communication device does not exceed the predetermined displacement threshold if the RSSI variation is within the predetermined tolerance.

11. The ranging apparatus of claim 10, when the instructions are executed by the processor, the ranging apparatus is caused to:
determine a time difference between a current time and a timestamp associated with a previous RSSI value used to determine the RSSI variation; and
in response to the time difference exceeding a staleness threshold, determine that the RSSI variation is unreliable and perform the ranging operation with the target AP to generate the ranging result.

12. The ranging apparatus of claim 10, further comprising:
an RSSI handling engine configured to:
obtain at least one RSSI value associated with the target AP without initiating an active scan or transmitting a probe request, by passively receiving one or more beacon frames, wherein the one or more beacon frames include beacon frames transmitted by a serving AP with which the wireless communication device is associated and/or beacon frames transmitted by one or more neighboring non-serving APs in OBSS; and
extract the at least one RSSI value from the passively received one or more beacon frames; and
wherein the ranging apparatus determines the RSSI variation based on the at least one RSSI value obtained by the RSSI handling engine.

13. The ranging apparatus of claim 9, when the instructions are executed by the processor, the ranging apparatus is caused to:
obtain motion data from one or more inertial sensors of the wireless communication device;
estimate a displacement of the wireless communication device based on the motion data; and
determine whether the displacement of the wireless communication device exceeds the predetermined displacement based on the estimated displacement and/or a motion state indicated by the motion data.

14. The ranging apparatus of claim 9, when the instructions are executed by the processor, the ranging apparatus is caused to:
select a most recent ranging result from the historical ranging results associated with the target AP as a current ranging result; or
compute the current ranging result by performing a statistical estimation over multiple ones of the historical ranging results associated with the target AP.

15. The ranging apparatus of claim 9, when the instructions are executed by the processor, the ranging apparatus is caused to:
select a ranging configuration for performing the ranging operation based on an operating mode of the ranging apparatus;
when the ranging mode is the power-saving ranging mode, perform the ranging operation using a reduced number of range measurement packets per burst; and
when the ranging mode is the accuracy-optimized ranging mode, performing the ranging operation using a full number of range measurement packets per burst.

16. The ranging apparatus of claim 9, wherein the ranging operation is performed in accordance with an IEEE 802.11 ranging procedure, comprising at least one of an IEEE 802.11 fine timing measurement (FTM) procedure and an IEEE 802.11az ranging procedure.

17. A wireless communication device comprising the ranging apparatus of claim 9.
